(19) United States
(12) Patent Application Publication
(10) Pub. No.: US 2012/0132038 A1
(43) Pub. Date: May 31, 2012

(54) Flexible Driver

(75) Inventor: Jeffery William Lefler, Pasadena, CA (US)

(73) Assignee: Technical Outsourcing Products, LLC, Surprise, AZ (US)

(21) Appl. No.: 13/306,319

(22) Filed: Nov. 29, 2011

Related U.S. Application Data
(60) Provisional application No. 61/417,538, filed on Nov. 29, 2010.

(51) Int. Cl. B25B 23/16

(52) U.S. Cl. 81/177.6

(57) ABSTRACT

A flexible driver for use within a lumen or other winding cavity. This driver is flexible, versatile, and user customizable. It may consist of a plurality of links and tips depending on the user's needs and the cavity in which it is to be used. It is designed to reduce the amount of unintended and uncontrolled movement between individual link thus eliminating accidental disengagement during use and unintentional rotational movement within the system.

### RELATED U.S. APPLICATION DATA

This application is a non-provisional of and claims the benefit of the filing date of U.S. Provisional Application No. 61417538 filed on 29 Nov., 2010.

### BACKGROUND

The present invention relates generally to the field of hand tools, and in particular to flexible drivers. Several devices are known that allow a user to use a flexible driver within a body lumen or other winding cavity. Among these are segmented tools comprising a series of connecting members attached to one another in some fashion. One such device comprises a series of connected segments forming a chain. Another is made of a series of nested ball-and-socket connections. Advantageously, all of these devices, especially when the series of connecting members is of a sufficient length, allow the user to use the tool to reach a portion of the body or other winding cavity that would otherwise be inaccessible and give the user more direct control of the task at hand.

### BRIEF SUMMARY OF THE INVENTION

Accidental disassembly and non-uniform or unintentional movement among individual links continues to be a problem with flexible tools. Disengagement during use can cause significant damage to the cavity the tool is being used in. Individual and/or non-uniform movement among components (such as spinning or rattling) can also cause damage to the cavity and make it difficult to wind the tool through the cavity to a desired location—especially when the cavity is particularly tortuous. The principal source of such movement and disassembly is commonly thought to be an inefficient connection or weak attachment between the components.

The present inventor, however, has discovered that making a connecting member that accomplishes a more secure fit when the connecting member is attached to another would provide numerous benefits, including a less damage to the cavity, greater applications in particularly tortuous cavities, prevention of accidental disassembly during use, and an overall increase in longevity of the tool. In accordance with the invention, then, the secure fit of the connecting members is enhanced by utilizing a channeled spherical-hexagonal configuration. Such configuration permits the connecting members to attach to one another to form a chain which terminates in a tip, thereby permitting the tool to function against an object within a winding cavity while virtually eliminating individual movement among members and/or disengagement between the connected portions.

Various other objects, features, and advantages of the invention will become readily apparent by reading the following description in conjunction with the drawings, which are shown by way of example only. The preferred embodiments of the present invention will hereinafter be described in conjunction with the appended drawings, wherein like designations denote like elements.

### BRIEF DESCRIPTION OF THE DRAWINGS

FIG. 1 illustrates a flexible driver embodying the principles of the present invention.

FIG. 2 consists of FIGS. 2A and 2B and illustrates a dowel embodying the principles of the present invention.

FIG. 3 consists of FIGS. 3A, 3B, 3C, and 3D and illustrates a series of links forming a chain embodying the principles of the present invention.

FIG. 4 is a perspective view illustrating alternative embodiments of the surface of a link embodying the principles of the present invention.

FIG. 5 is a perspective view illustrating alternative tips embodying the principles of the present invention.

FIG. 6 illustrates kit embodying the principles of the invention as shown in FIGS. 1-5.

FIG. 7 illustrates a method of use embodying the principles of the present invention.

### DETAILED DESCRIPTION

Referring now to the drawings in detail, this invention will be described by way of example and with reference to preferred embodiments thereof, however, it is to be understood that modifications and improvements may be made without departing from the scope or spirit of the invention. It should be noted that various changes and modifications to the presently preferred embodiments described herein will be apparent to those skilled in the art. Such changes and modifications may be made without diminishing its attendant advantages. It is, therefore, intended that such changes and modifications be included within the present invention. In this application, the term “driver” refers to any mechanical component that exerts a force on another to produce motion, such as, for example, a probe or a screwdriver.

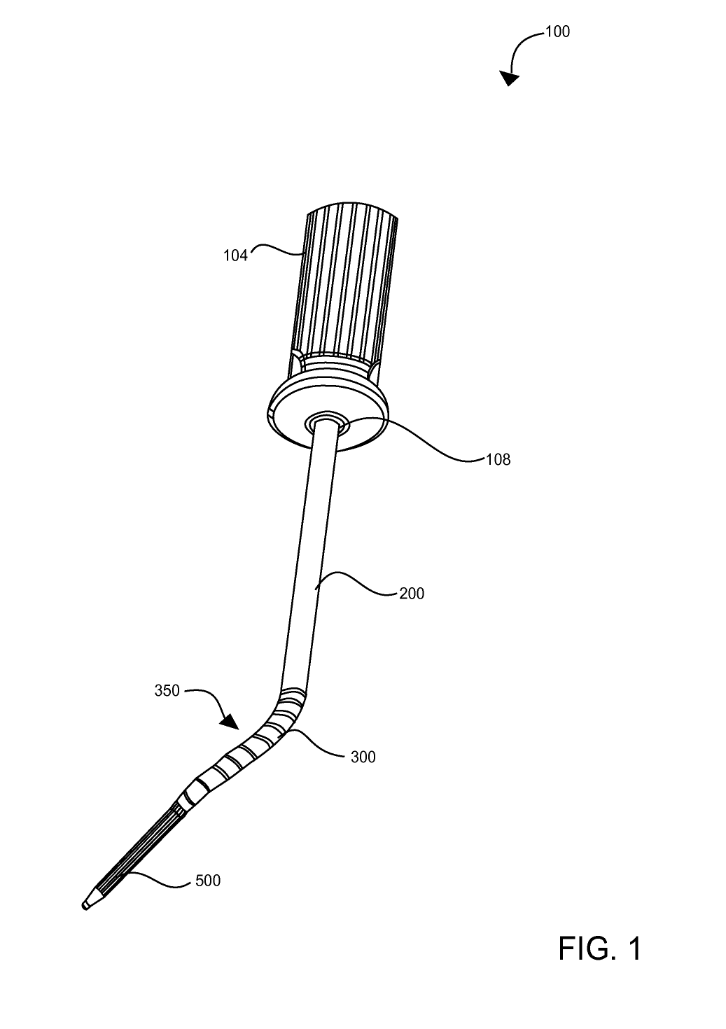

Referring now to FIG. 1, illustrating flexible driver 100 according to an embodiment of the present invention. Flexible driver 100 is shown having a grip 104, an elongated dowel 200, a plurality of links 300 forming link chain 350, and at least one tip 500. The proximal end of dowel 200 may be connected to the distal end of grip 104 via aperture 108 as shown. In this manner, grip 104 may serve the purpose of functioning as a handle or holder by which the user may grasp flexible driver 100. In other embodiments, dowel 200 may be connected to grip 104 via friction fit, adhesives, molding, or any other means sufficient to accomplish the purpose of a secured relationship between grip 104 and dowel 200.

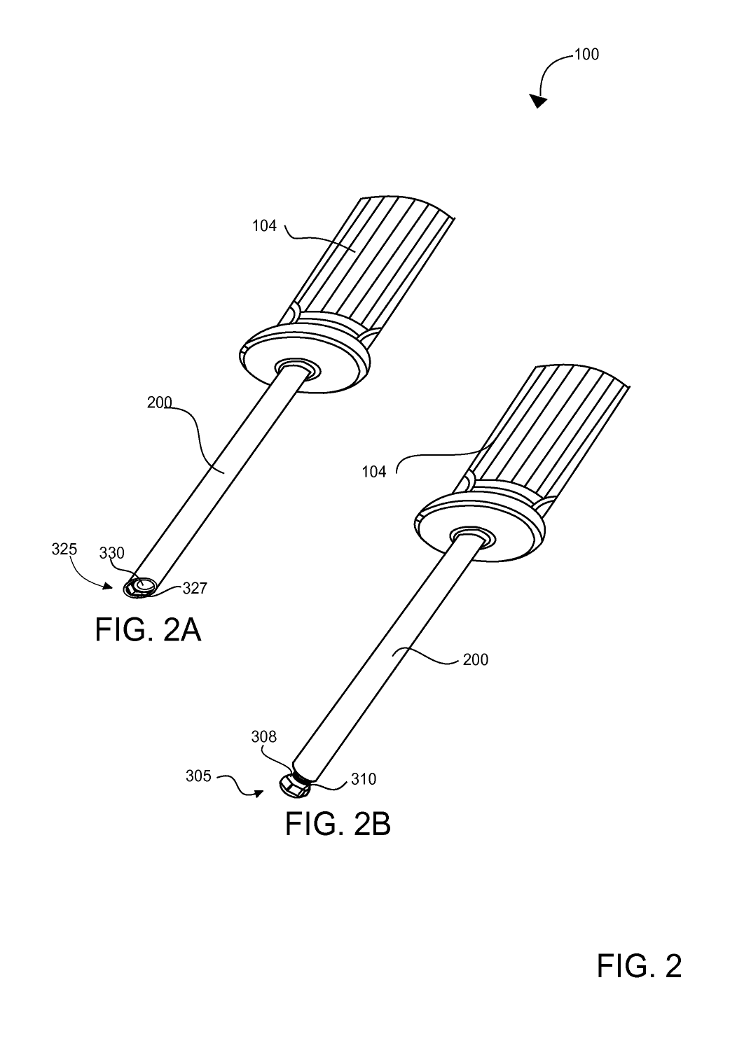

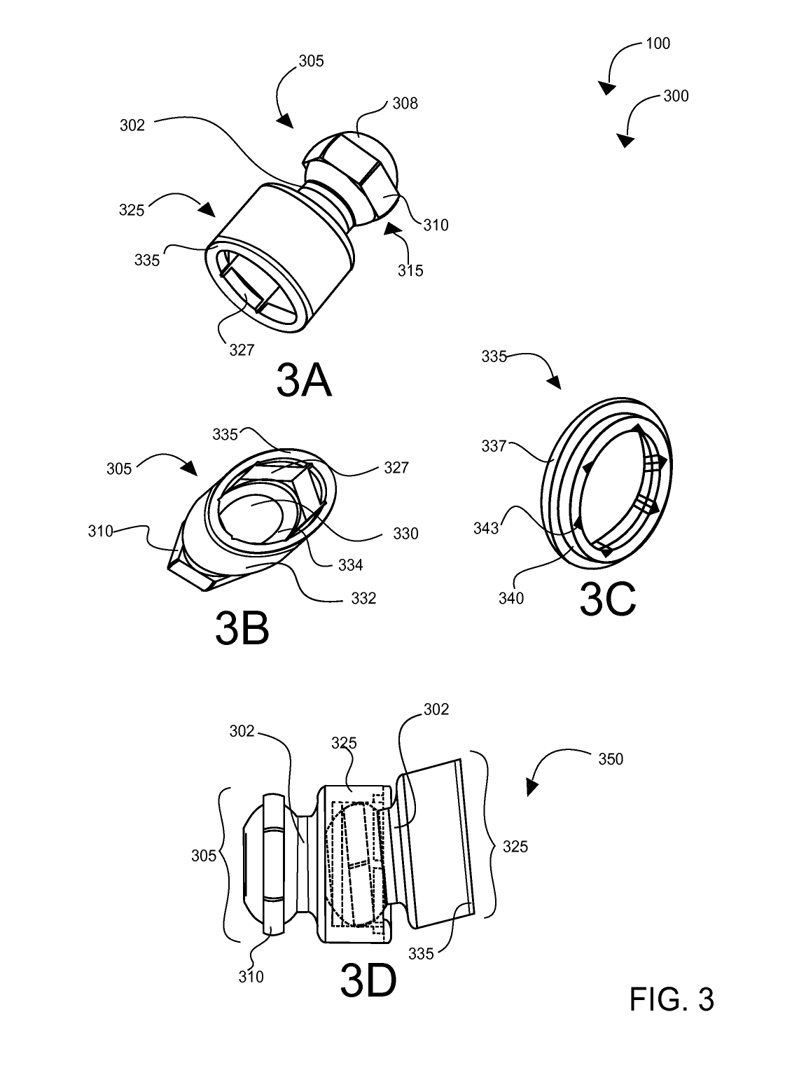

Grip 104 may comprise any material suitable for the purpose of gripping or holding including, but not limited to elastomeric materials and non elastomeric material including polymers, metals and metal alloys, wood, ceramic or any other suitable material. The dimensions of grip 104 are such that the user is able to comfortably hold grip 104 and rotate flexible driver 100. The distal end of dowel 200 may be connected to the proximal end of at least one link 300 (discussed in further detail in FIGS. 2 and FIG. 3). As mentioned above, flexible driver 100 comprises a plurality of link 300. In this manner, a plurality of a user determined number, n, of link 300 creates link chain 350 comprising n link 300.

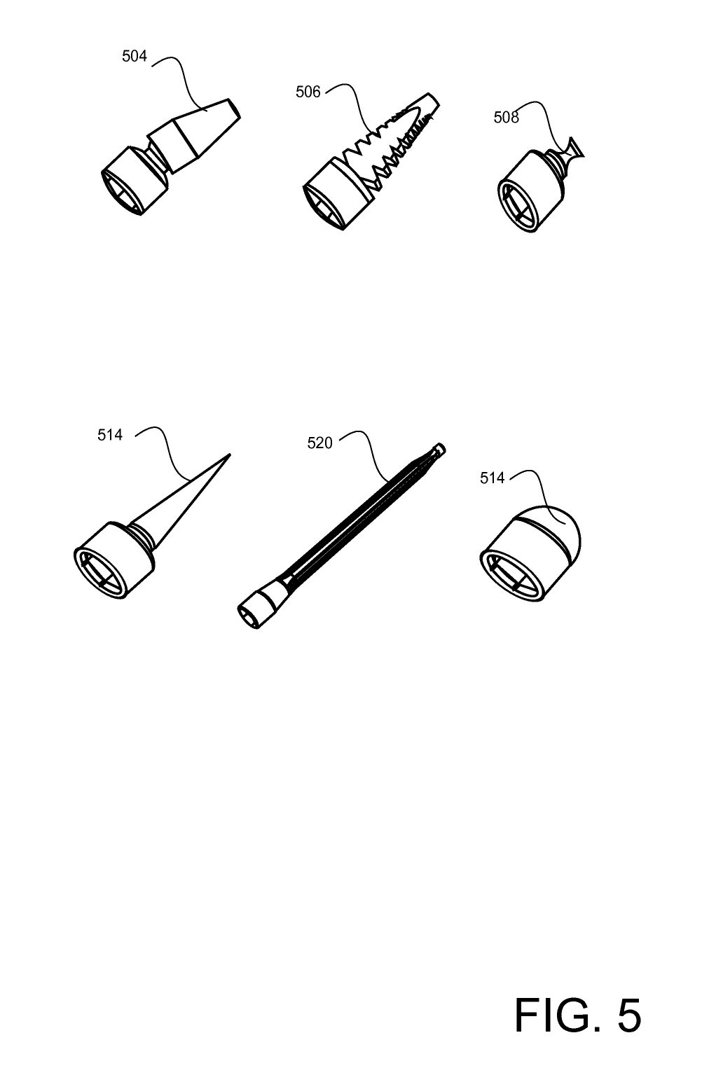

Finally, tip 500 may be attached to the distal link 300 in link chain 350 as shown. Tip 500 may comprise probe, a needle, a reemer, tube, screw, socket, or any other means for operating against or within a substrate (discussed in further detail in FIG. 5). In this manner, when grip 104 is turned, the rotational force is transferred from user to grip 104 through dowel 200 to link chain 350 and tip 500, such that flexible driver 100 imparts forceful pressure on another object within a winding cavity. By way of example, FIG. 1 depicts flexible driver 100 comprising 1 one link chain 350, where n=8 link 300 and one tip 500. Within the present embodiment, FIG. 1 depicts flexible driver 100 as substantially cannulated or hollow, however, it should be understood that in alternative embodiments, flexible driver 100 may be solid or partially cannulated or partially hollow. Finally, link 300, dowel 200, and/or tip 500 of flexible driver 100 may be comprised of any suitable material sufficient to permit flexible driver 100 to operate within and/or against another object in a cavity, including plastics and other elastomeric or nonelastomeric polymers, aluminum, stainless steel, other metals or metal alloys, alloys, such as aluminum, stainless steel, or any material suitable for their intended purpose.

Referring now to FIG. 2, consisting FIGS. 2A and 2B, and illustrating dowel 200. By way of example, FIG. 2 depicts dowel 200 as an elongated bar in a substantially cylindrical configuration, however, it should be understood that dowel 200 may be any elongated shape sufficient to permit it to function as a connector between link 300 and grip 104, such as, for example, a rectangular or triangular bar.

The distal end of dowel 200 may comprise male coupler 305, as illustrated in FIG. 2B. In the present embodiment, male coupler 305 is configured in a substantially spherical hexagonal shape, however it should be understood that other polysided configurations are contemplated without departing from the scope and spirit of the invention. Within the present embodiment, male coupler 305 comprises sphere 308 which may be surrounded by a plurality of protrusion 310 extending lengthwise along the outer perimeter of male coupler 305. In this manner, male coupler 305 comprises a substantially spherical hexagonal shape as shown. By way of example, within the present embodiment as illustrated by FIG. 2, protrusion 310 is a substantially parallelepiped shape. In alternative embodiments, protrusion 310 may be any polyhedroid protrusion sufficient to work in conjunction with and function as a staying mechanism for each link 300 within link chain 350 (discussed in further detail below). Further, within the present embodiment as illustrated in FIG. 2, male coupler 305 is comprised of six (6) protrusion 310 form ring 315 (three (3) of which are visible) resulting in a substantially hexagonal shape. In alternative embodiments, a plurality of protrusion 310 may result in other polysided configurations, such as, for example, octagonal, or pentagonal. In alternative embodiments (not shown), male coupler 305 may be configured to attach to any conventional screwdriver (such as slotted or Phillips).

In alternative embodiments, the distal end of dowel 200 may comprise female coupler 325 as depicted in FIG. 2A. Within the present embodiment, female coupler 325 may comprise a plurality of channel 327 extending lengthwise and arranged circumferentially within inner cavity 330 as shown. In this manner, female coupler 325 comprises a substantially spherical hexagonal shape as shown that is complementary to male coupler 305. By way of example, within the present embodiment as illustrated by FIG. 2, channel 327 is a substantially parallelepiped shape. In alternative embodiments, channel 327 may be any polyhedroid configuration sufficient to work in conjunction with and function as a staying mechanism for each link 300 within link chain 350 (discussed in further detail below). In this manner, male coupler 305 and female coupler 325 work in concert to secure a plurality of link 300 together to form link chain 350 while at the same time preventing non-uniform and unconcerted movement among individual link(s) 300.

As mentioned above, the distal end of dowel 200 may comprise male coupler 305 or female coupler 325. In this manner, the user is free to choose which end of link 300 (discussed in detail in FIG. 3) he or she wishes to connect to dowel. It should be understood that either configuration may be desirable depending on the particular cavity flexible driver 100 is to be used in. In alternative embodiments (not shown), female coupler 325 may be configured to attach to any conventional screwdriver (such as slotted or Phillips).

As mentioned above, the proximal end of dowel 200 may be coupled to the distal end of grip 104 while the distal end of dowel 200 may be coupled to the proximal end or distal end of link 300 (discussed in further detail below). In this manner, dowel 200 operates as a stabilizer between link chain 350 and grip 104. Further, dowel 200 may further serve the purpose of transferring rotational force from grip 104 to link chain 350 and tip 500, thus allowing flexible driver 100 accomplish the goal of rotable movement while acting against an object deep within a cannulated cavity. In alternative embodiments, the handle and shaft of a commercially available screwdriver may accomplish the same task on link chain 350.

Referring now to FIG. 3, consisting of FIGS. 3A, 3B, 3C, and 3D and illustrating link 300, retainer 335, and a link chain 350 comprising n link 300 where n=2 (FIG. 3D). Link 300 may further comprise neck 302, a proximal end having male coupler 305, a distal end having female coupler 325 and retainer 335. Further, link 300 may be of a substantially hollow or cannulated configuration. As a result, in alternative embodiments, link chain 350 may be wholly or partially solid. As discussed above, flexible driver 100 may comprise a plurality of n number link 300 which may be removably assembled to form link chain 350. In this manner, flexible driver 100 is capable of rotational movement over a bend radius, R, such that the user may thread it through a winding cavity. Link chain 350 is capable of moving about a rotational axis, resulting in a series of substantially “c” and/or “s” shapes, depending on the number n of link 300 and resultant length l of link chain 350.

As depicted in FIGS. 3A and 3D, link 300 may further comprise neck 302. According to an embodiment of the present invention, neck 302 may be positioned between the distal and proximal end of link 300 as shown. In alternative embodiments, neck 302 may be positioned substantially on or near the midsection, and generally between male coupler 305 and female coupler 325 as shown. Neck 302 may be a smaller circumference than the outer circumference of female coupler 325 and/or male coupler 305. In this manner, neck 302 may function as a stable connector between male coupler 305 and female coupler 325 while still permitting link chain 350 to move about a rotational axis. Within the present embodiment, neck 302 permits link chain 350 to move freely about a rotational access while substantially decreasing the chance for accidental disengagement of individual link 300 from link chain 350 during use. Further, neck 302 also prevents non-uniform and individual movement among the plurality of link 300 that link chain 350 comprises.

As illustrated in FIG. 3A, link 300 may comprise male coupler 305. Male coupler 305 may be proximally adjacent to neck 302 and generally on one end of link 300 as shown. Male coupler 305 may further comprise sphere 308 which may be bisected by a plurality of protrusion 310 extending lengthwise to form ring 315 along the perimeter of male coupler 305. In this manner, male coupler 305 may comprise a substantially spherical hexagonal shape as shown. By way of example, within the present embodiment as illustrated by FIG. 2, protrusion 310 is a substantially parallelepiped shape. In alternative embodiments, protrusion 310 may be any polyhedroid protrusion sufficient to work in conjunction with protrusion 310 and function as a staying mechanism for each link 300 within link chain 350. Further, within the present embodiment as illustrated in FIG. 3, six (6) protrusion 310 (three of which are visible in FIG. 3A) form ring 315 resulting in a substantially hexagonal shape surrounding sphere 308. In alternative embodiments, a plurality of protrusion 310 may surround sphere 308 resulting in other polysided configurations, such as, for example, octagonal, or pentagonal.

As illustrated by FIG. 3B, link 300 further comprises female coupler 325. Female coupler 325 may be distally adjacent to neck 302 and generally on one end of link 300 as shown. Female coupler 325 may comprise outer surface 332 and inner cavity 330 which comprises a plurality of channel 327 extending lengthwise and arranged circumferentially within inner cavity 330 as shown. Female coupler 325 may further comprise dome 334 which may be located within inner cavity 330 and may be located substantially above the plurality of channel 327 as shown. The dimensions of dome 334 may be complementary to sphere 308 such that when male coupler 305 is inserted into female coupler 325, dome 334 substantially houses sphere 308 while sphere 308 is nested within dome 334. Further, inner cavity of female coupler 325 may comprise a substantially spherical-hexagonal shape as shown. By way of example, within the present embodiment as illustrated by FIGS. 3A and 3B, channel 327 is a substantially parallelepiped shape.

In alternative embodiments, channel 327 may be any polyhedroid indentation sufficient to work in conjunction with protrusion 310 and function as a staying mechanism for a plurality of link 300 within link chain 350. Within the embodiment depicted by the figures, plurality of channel 327 is shown as substantially hexagonal configuration, however it should be understood that any polysided configuration is contemplated (including, but not limited to, octagonal, pentagonal, or triagonal) without departing from the scope and spirit of the invention.

As illustrated by FIG. 3C, link 300 may further comprise retainer 335. Retainer 335 may be positioned within the distal-most portion of female coupler 325. Retainer 335 maybe a substantially ring-like structure comprising lip 337 and cylinder 340. Within the present embodiment, lip 337 may be located within the proximal end of retainer 335 while cylinder 340 is located within the distal end of retainer 335. Lip 337 may comprise an outer circumference that is substantially equivalent to the outer circumference of female coupler 325.

Cylinder 340 may comprise a circumference that is approximately equal to the circumference of inner cavity 330.

Lip 337 may comprise a plurality of groove 343. Groove 343 traverses the inside cylinder 340 as shown. Further, within the present embodiment, the dimensions of groove 343 are proportional and complementary to protrusion 310 and channel 327. In a preferred embodiment, retainer 335 may be welded in place over the distal-most portion of female coupler 325. In alternative embodiments, retainer 335 may be molded or affixed via adhesives, brads, screws, nails, or any other appropriate attaching means to accomplish a secure fit between retainer 335 and female coupler 325. Therefore, retainer 335 works as a part of female coupler 325 and in conjunction with male coupler 305 to prevent accidental disengagement of link chain (and therefore increasing the overall life of) flexible driver 100 while it is in use.

As demonstrated in the figures, retainer 335 may be connected to female coupler 325 such that forms the outer edge of female coupler 325 while cylinder 340 forms the inner edge adjacent to neck 302 as shown. Further, retainer 335 may be connected to female coupler 325 such that each groove 343 aligns with channel 327 and protrusion 310. Within the present embodiment, when a user wishes to use flexible driver 100 in any given winding cavity, he or she selects the number n of link 300 she needs to achieve the desired length l of link chain 350. The user then inserts the male connector 305 of one link 300 into female connector 325 of another link 300 thus creating a coupled arrangement as demonstrated in FIG. 3D. The user repeats these steps until the desired length l comprising n link 300 is created.

Protrusion 310 and/or channel 327 may further serve the purpose of functioning as a stop for male coupler 305 and/or female coupler 305 in order to prevent each individual link 300 of link chain 350 from spinning while in use. This ensures that rotational movement of link chain 350 is uniform throughout entire length. Further, engaged as members of link chain 350, protrusion 310 and channel 327 permit individual swiveling or spinning of link 300 in link chain 350. The components of link 300 work in concert to ensure minimal binding among n number link 300 while torque is applied through link chain 350. As a result, vibrating or rattling (“chatter”) between link 300 that forms link chain 350 may be eliminated while errors in axial movement (“slop”) are significantly decreased.

As mentioned above and illustrated in FIG. 3D, the proximal and distal ends of link 300 may attach to one another to form link chain 350. In this manner, flexible driver 100 may wind through a tortuous cavity, such as a body lumen. Further, the user may select any any number n of link 300 sufficient to create link chain 350 of a length l best suited to accomplish the user's task in a particular cavity. When flexible driver 100 is in use, rotational force is transmitted from grip 104 through dowel 200 to link chain 350 and tip 500. Therefore, link chain 350 permits flexible driver 100 to operate over a bend radius, R, which, depending on the number of link 300 in link chain 350 may extend up to 90 degrees. In alternative embodiments (not shown), link chain 350 may be a predetermined length and configured to attach to any conventional screwdriver (such as slotted or Phillips). In alternative embodiments, the user attaches a predetermined length l link chain 350 in the manner described above for use with his or her own standard driver.

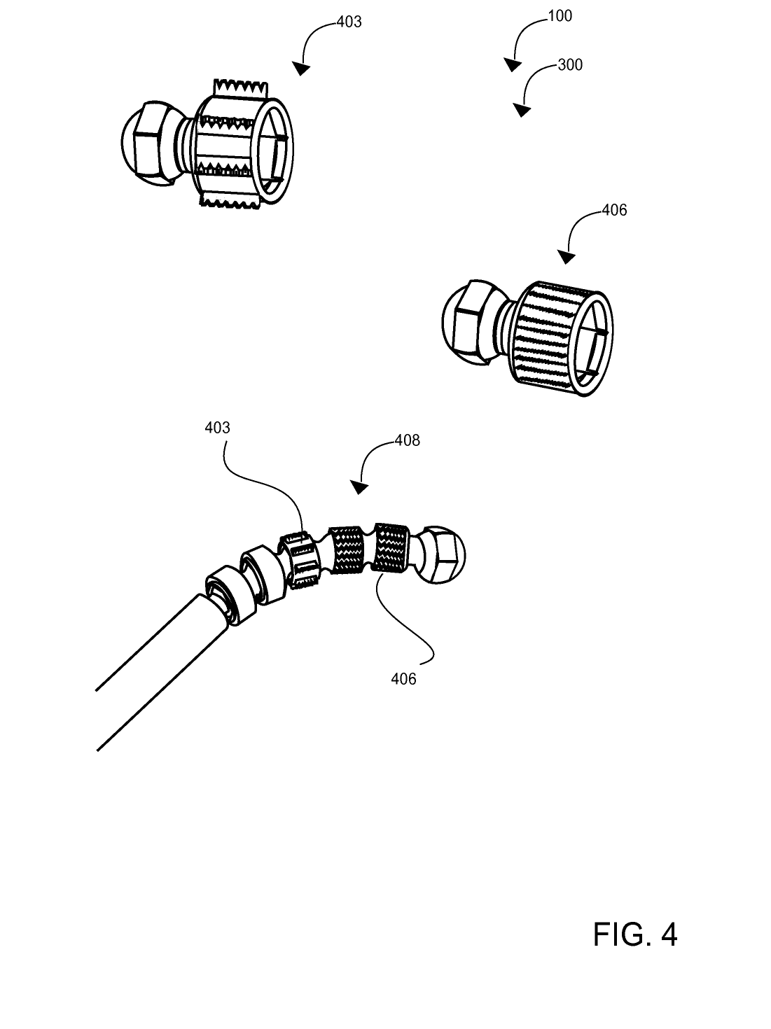

In alternative embodiments, link chain 350 may comprise a plurality of modified link(s) 300 as depicted in FIG. 4. By way of example, FIG. 4 depicts surface 332 modified with teeth 403. When link 300 is modified with teeth 403, flexible driver 100 is capable of boring the cavity or object it is used on or within. In alternative embodiments, surface 332 may be abraded 406. When the surface 302 is abraded 406, flexible drier is capable of gradually eroding the cavity or substrate it is used on or in. It should be understood that additional modifications of to surface 302 are possible without deviating from the scope of the presently described invention. In this manner, flexible driver 100 may serve the purpose of acting against or modifying the inside of a cavity or substrate (such as, for example, reaming, shearing, burring, and/or smoothing). Further, it is possible to use a combination 408 of different embodiments of link 300 within a link chain 350 links as shown. In this manner flexible driver 100 is capable of, for example, burring a particular portion of a cannula while leaving other portions of the same cannula intact or unaffected. Further, it should be understood that surface 302 may be configured in varying degrees of rough to smooth so as to permit the user to select an embodiment of surface 302 to fit his or her unique shaping needs. In this manner, when in use, flexible driver 100, within the present embodiment, prevents damage to the substrate of cavity by reducing the opportunity for improper reaming or abrading, pinching, snagging, or catching against a cavity wall or substrate.

Referring now to FIG. 5, illustrating exemplary alternative embodiments of tip 500. By way of exemplary means only, FIG. 5 illustrates an embodiment of tip 500 wherein tip 500 comprises a smooth surfaced cone 504. Further, by way of exemplary means only, FIG. 5 illustrates an embodiment of tip 500 wherein tip 500 comprises a substantially triangular structure with jagged edges 506. Further, by way of exemplary means only, FIG. 5 depicts tip 500 comprising a slotted screwdriver 508. It should be understood that while FIG. 5C depicts a slotted screwdriver, other types of screws, such as, but not limited to, Phillips, or Allen, are contemplated. Further, by way of exemplary means only, tip 500 may further comprise a generally pointed elongated structure that may be used for piercing 514. In alternative embodiments, and by exemplary means only, tip 500 may further comprise an abraded elongated cylinder 520 that may be used for abrading the inner walls of a cavity. Finally, by exemplary means only, tip 500 may comprise a rounded member 514 that may be used for probing. It should be understood that the embodiments according to FIG. 5 are exemplary and other embodiments contemplated without deviating from the scope of the present invention being described.

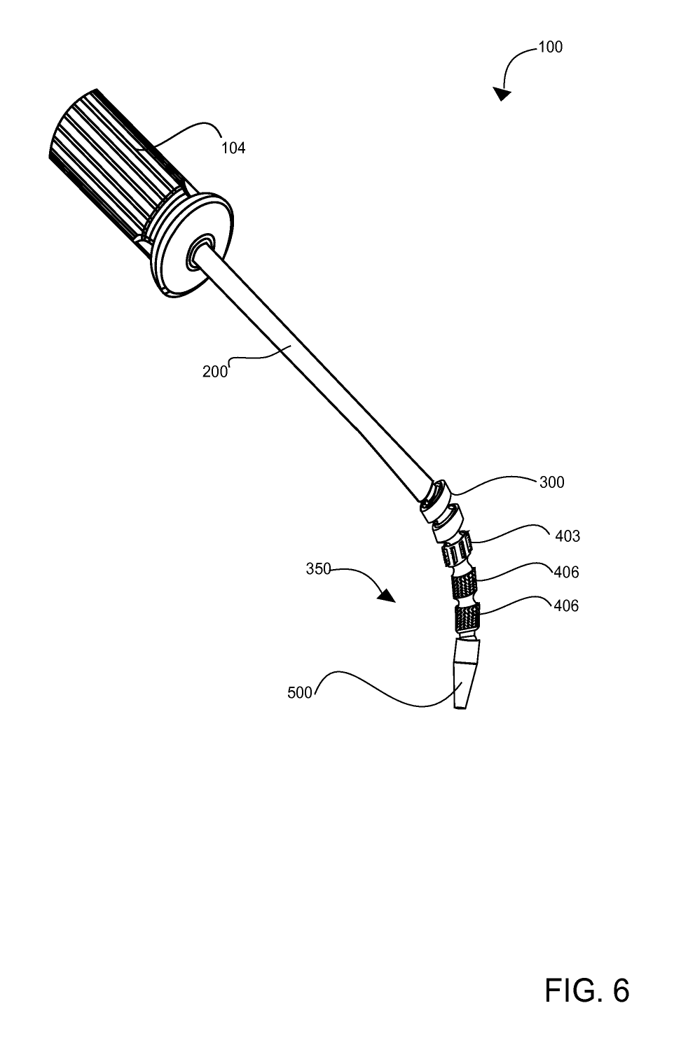

Referring now to FIG. 6, illustrating kit 600 of flexible driver 100 shown in FIGS. 1-5. Kit 600 may include at least one grip 104; at least one dowel 200; a plurality of link 300 forming one (1) link chain 350; a plurality of tip 500; and at least one set of user instructions. Flexible driver 100 may be preferably manufactured and provided for sale in a wide variety of sizes and shapes for a wide assortment of applications. Within the present embodiment, dowel 200 may be removably received by the distal end of grip 104. The proximal or distal end of link 300 may be removably connected to dowel 200. In alternative embodiments, link 300 may be removably attached to a standard driver (such as, but not limited to, slotted or Phillips). The proximal and/or distal end of link 300 may be removably attached to another link 300 to form link 300 chain 350 comprising a plurality of link 300. Further, the proximal or distal end of link 300 may be removably attached to any one of a plurality of tip 500. In this way the present invention is customizable and may be assembled according to user-preference based on the object flexible driver 100 is to be used against and/or within. Kit 600 contents may comprise the various components made from different materials as mentioned above. By way of example, FIG. 6 shows flexible drive 100 further comprising link chain 350 comprising one (1) tip 500 comprising smooth surfaced cone 504, two (2) unmodified link 300, two (2) link 300 comprising abraded surface 406, and one (1) link 300 comprising toothed surface 403 for a link chain 350 totaling five (5) link 300; and one grip 104.

The embodiments of the invention described herein are exemplary and numerous modifications, variations, and rearrangements can be readily envisioned to achieve substantially equivalent results, all of which are intended to be embraced within the spirit and scope of the invention. Finally, flexible driver 100 provides a system whereby the components may be manufactured separately providing for decreased costs related to shipping. Further, the user has the additional benefit that the system is easily assemblable and disassemblable for transport between locations and in/or out of the sanitation machine. The user also benefits in that they may select individual components to work with their existing tool set instead of having to purchase a pre-packaged unit.

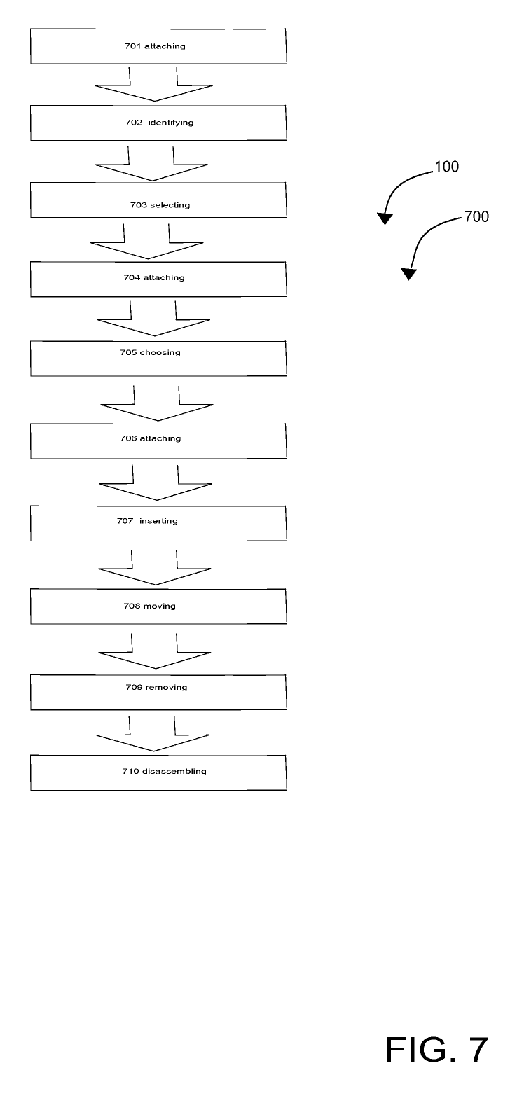

Referring now to FIG. 7, illustrating method of use 700, which may comprise the following steps of assembling and using flexible driver 100 according to user-preference including: step one 701 attaching grip to dowel 200; 702 identifying the appropriate number n of link 300 having the desired configuration of surface 302; 703 selecting the type of link 300 needed; 704 attaching the distal and/or proximal ends of n link 300 to form link chain 350; 705 choosing a tip 500; 706 attaching tip 500 to terminal link 300 in link chain 350; 707 inserting flexible driver 100 into a winding cavity; 708 moving flexible driver 100 to operate against an object located in the winding cavity: and 709 removing flexible driver 100. Method of use 700 further comprises optional step 710 of disassembling flexible driver 100 for storage and/or transport. In alternative embodiments, method of use 700 may comprise the optional step 711 of attaching link chain 350 to a standard driver (not shown).

It should be noted that the steps described in the method of use can be carried out in many different orders according to user preference. Upon reading this specification, it should be noted that, under appropriate circumstances, when considering such issues as user, design, and marketing preferences, cost considerations, structural requirements, available materials, technological advances, etc., other methods of use arrangements such as, for example, different orders within above-mentioned list, elimination or addition of certain steps, including or excluding certain maintenance steps, etc., may present a suitable alternative.

From the foregoing description, it should be appreciated that a preferred embodiment and a method for operating against an object using flexible driver 100 re provided and present significant benefits that would be apparent to one skilled in the art. Furthermore, it should be appreciated that a vast number of variations in the embodiments exist. Lastly, it should be appreciated that these embodiments are preferred exemplary embodiments only, and are not intended to limit the scope, applicability, or configuration of the invention in any way. Rather, the foregoing detailed description provides those skilled in the art with a convenient framework for implementing a preferred exemplary embodiment of the invention. It being understood that various changes may be made in the function and arrangement of elements described in the exemplary preferred embodiment without departing from the spirit and scope of the invention as set forth in the appended claims.

What is claimed is:

1. An apparatus for operating against a substrate having:
a turnable handle having an aperture;
a plurality of links, each link comprising a male end and female end, the female end configured to receive and actively secure the male end of an adjacent link;
a support inserted into the aperture of the handle and having a terminal end configured to couple to at least one link; and
a tip comprising a terminal end and a coupler, the coupler being configured to connect to at least one of said plurality of links
wherein at least one of said plurality of links couples to the terminal end of said support and wherein rotational force is applied to the turnable handle and the support is used to manipulate the plurality of links and the tip in a clockwise and/or counter-clockwise direction.

2. The apparatus of claim 1 wherein the support is hollow.

3. The apparatus of claim 1 wherein the tip is hollow.

4. The apparatus of claim 1 wherein at least one link is hollow.

5. The apparatus of claim 1 wherein the male end of the link attaches to the female end of an adjacent link form a flexible shaft configured to permit coordinated movement between said plurality of links.

6. The apparatus of claim 1 wherein the female end of the link attach to the male end of an adjacent link form a flexible shaft configured to permit coordinated movement between said plurality of links.

7. The apparatus of claim 4 wherein the male end comprises a plurality of protrusions and wherein the female end comprises a plurality of channels to removably receive said plurality of protrusions.

8. The apparatus of claim 1 wherein the outer surface of at least one link has a textured surface.

9. The apparatus of claim 1 wherein the tip has a textured surface.

10. The apparatus of claim 1 wherein the user determines the number of said plurality of links.

11. The apparatus of claim 1 further comprising a customizable kit according to user specifications wherein the kit includes a handle; a plurality of links; a support mounted to the handle; and a tip.

12. An apparatus for operating against a substrate having:
a turnable handle having an aperture;
a plurality of links, each link comprising a male end and female end, the female end configured to receive and actively secure the male end of an adjacent link;
a support inserted into the aperture of the handle and configured to couple to the a link; and
a tip comprising a terminal end and a coupler, the coupler being configured to couple to at least one of said plurality of links
wherein at least one of said plurality of links couples to a commercially available screwdriver, and wherein said commercially available screwdriver is used to manipulate the plurality of links to move the tip in a clockwise and/or counterclockwise direction.

13. The apparatus of claim 12 wherein the male end of the link attaches to the female end of an adjacent link form a flexible shaft configured to permit coordinated movement between said plurality of links.

14. The apparatus of claim 12 wherein the female end of the link attach to the male end of an adjacent link form a flexible shaft configured to permit coordinated movement between said plurality of links.

15. The apparatus of claim 12 wherein the male end comprises a plurality of protrusions and wherein the female end comprises a plurality of channels to removably receive said plurality of protrusions

16. The apparatus of claim 12 wherein the outer surface of at least one link has a textured surface.

17. The apparatus of claim 12 wherein the tip has a textured surface.

18. A method of using a apparatus to operate against a substrate comprising the steps of: attaching a dowel to a grip; attaching a first link to said dowel; attaching a second link to a third link to form a chain; repeating the second step until said chain is a user determined length; attaching a tip to the terminal end of said chain; inserting said chain into a curved channel; applying rotational force to said grip; and removing said chain from curved channel.

19. A method of using a plurality of links to operate against a substrate comprising the steps of: attaching a first link to the terminal end of a screwdriver; attaching a second link to a third link to form a chain; repeating the second step until said chain is a user-determined length; attaching a tip to the terminal end of said chain; inserting said chain into a curved channel; applying rotational force to said grip; and removing said chain from curved channel

20. (canceled)
